(19) United States
(12) Patent Application Publication
(10) Pub. No.: US 2008/0101438 A1
(43) Pub. Date: May 1, 2008

(54) Apparatus and method for allocating frequency resources in an OFDMA mobile communication system

(75) Inventors: Sang Min Lee, Gyeonggi-do (KR); Tak-Ki Yu, Suwon (KR); Cheol-Woo You, Seoul (KR); Young-llo Jung, Gyeonggi-do (KR)

Correspondence Address: DOCKET CLERK, P.O. DRAWER 800889, DALLAS, TX, 75380, US

(73) Assignee: SAMSUNG ELECTRONICS Co., LTD., Suwon-si (KR)

(21) Appl. No.: 11/981,856

(22) Filed: Oct. 31, 2007

(30) Foreign Application Priority Data
Oct. 31, 2006 (KR) 2006-106367

(51) Int. Cl. H04B 1/713

(52) U.S. Cl. 375/132; 375/E01.034

(57) ABSTRACT

An apparatus and method for allocating frequency resources in an OFDMA mobile communication system. A hop group includes a plurality of hop units, each hop unit being minimum frequency resources which can be allocated in a two dimensional time-frequency domain and a total frequency band of the OFDMA mobile communication system is divided into subbands. A base station allocates at least one hop unit to each mobile station, permutes the sequence of hop units included in each hop group according to a first permutation sequence, allocates the hop units of the each hop group to subbands, permutes the sequence of hop units included in each of the subbands according to a second permutation sequence, and determines the positions of the hop units permuted according to the second permutation sequence to be the positions of physical subcarriers allocated to the each mobile station.

### CROSS-REFERENCE TO RELATED APPLICATION(S) AND CLAIM OF PRIORITY

The present application claims the benefit under 35 U.S.C. § 119(a) of a Korean Patent Application filed in the Korean Intellectual Property Office on Oct. 31, 2006 and assigned Serial No. 2006-106367, the entire disclosure of which is hereby incorporated by reference.

### TECHNICAL FIELD OF THE INVENTION

The present application generally relates to an apparatus and method for allocating frequency resources in an Orthogonal Frequency Division Multiple Access (OFDMA) mobile communication system. More particularly, the present invention relates to an apparatus and method for allocating frequency resources to achieve frequency diversity gain in an OFDMA mobile communication system.

### BACKGROUND OF THE INVENTION

In general, future-generation communication systems are under development to provide high-speed large data transmission and reception services to mobile stations. Unlike a wired channel environment, in the wireless channel environment of a mobile communication system, errors are inevitable due to a variety of factors including multipath interference, shadowing, propagation attenuation, time-variant noise, interference and fading.

The resulting information loss causes severe distortion in an actual transmission signal, thereby degrading the overall performance of the mobile communication system. To eliminate fading-caused instability in communications, diversity schemes are used. The diversity schemes are largely classified into time diversity, frequency diversity, and antenna diversity (i.e. spatial diversity). A major frequency diversity scheme is frequency hopping.

If the frequency characteristics of channels are known, an OFDMA mobile communication system allocates each mobile station (MS) to subcarriers that suit the frequency characteristics of the MS using Dynamic Channel Allocation (DCA) techniques. Without knowledge of the frequency characteristics of channels, the OFDMA mobile communication system allocates the MS to subcarriers scattered across a total frequency band by frequency hopping. The frequency hopping-based subcarrier allocation brings a frequency diversity gain to the MS.

Conventionally, the frequency hopping method allocates subcarriers distributed over the total frequency band to the MS in an arbitrary manner. If a particular MS wants to use a partial frequency band instead of the total frequency band, subcarrier allocation is not viable. Accordingly, there exists a need for enabling an MS to achieve a frequency diversity gain by allocating part of a total frequency band to the MS in an OFDMA mobile communication system.

### SUMMARY OF THE INVENTION

To address the above-discussed deficiencies of the prior art, it is a primary object of the present invention to address at least the problems and/or disadvantages and to provide at least the advantages described below. Accordingly, an aspect of exemplary embodiments of the present invention is to provide an apparatus and method for allocating frequency resources to achieve a frequency diversity gain in an orthogonal frequency division multiple access (OFDMA) mobile communication system.

Another aspect of exemplary embodiments of the present invention is to provide an apparatus and method for allocating frequency resources such that a frequency diversity gain can be achieved using a partial frequency band in an OFDMA mobile communication system.

In accordance with an aspect of exemplary embodiments of the present invention, there is provided a method for allocating frequency resources in a base station (BS) in an OFDMA mobile communication system, in which when a hop group includes a plurality of hop units, each hop unit being minimum frequency resources which can be allocated in a two dimensional time-frequency domain and a total frequency band of the OFDMA mobile communication system is divided into subbands, at least one hop unit is allocated to each mobile station (MS), the sequence of hop units included in each hop group is permuted according to a first permutation sequence, the hop units of the each hop group are allocated to subbands, the sequence of hop units included in each of the subbands is permuted according to a second permutation sequence, and the positions of the hop units permuted according to the second permutation sequence are determined to be the positions of physical subcarriers allocated to the each MS.

In accordance with another aspect of exemplary embodiments of the present invention, there is provided an apparatus for allocating frequency resources in an OFDMA mobile communication system, in which when a hop group includes a plurality of hop units, each hop unit being minimum frequency resources which can be allocated in a two dimensional time-frequency domain and a total frequency band of the OFDMA mobile communication system is divided into subbands, a BS allocates at least one hop unit to each MS, permutes the sequence of hop units included in each hop group according to a first permutation sequence, allocates the hop units of the each hop group to subbands, permutes the sequence of hop units included in each of the subbands according to a second permutation sequence, and determines the positions of the hop units permuted according to the second permutation sequence to be the positions of physical subcarriers allocated to the each MS.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates the configuration of an OFDMA mobile communication system according to an exemplary embodiment of the present invention; and

FIG. 2 illustrates a frequency allocation method in the OFDMA mobile communication system according to an exemplary embodiment of the present invention.

Throughout the drawings, the same drawing reference numerals will be understood to refer to the same elements, features and structures.

### DETAILED DESCRIPTION OF THE INVENTION

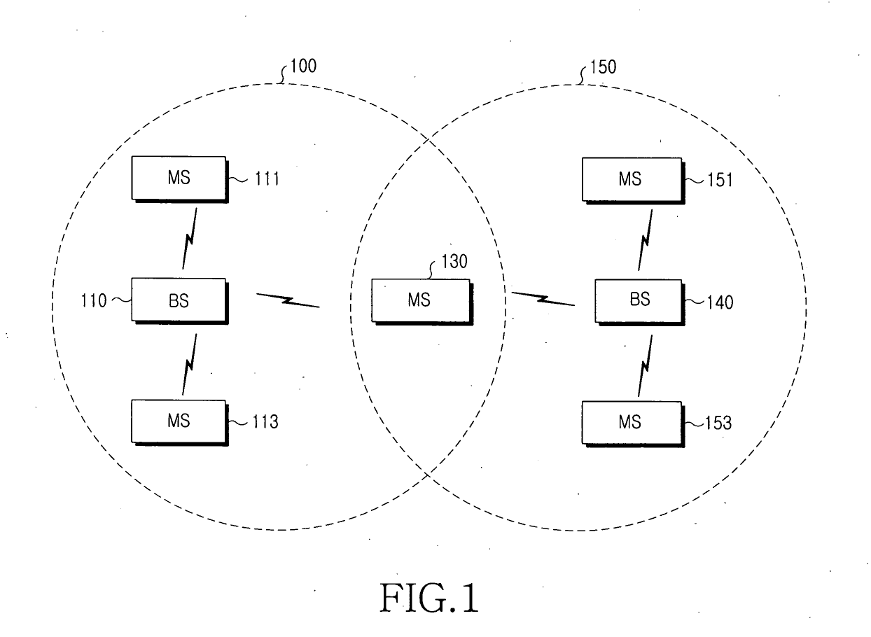

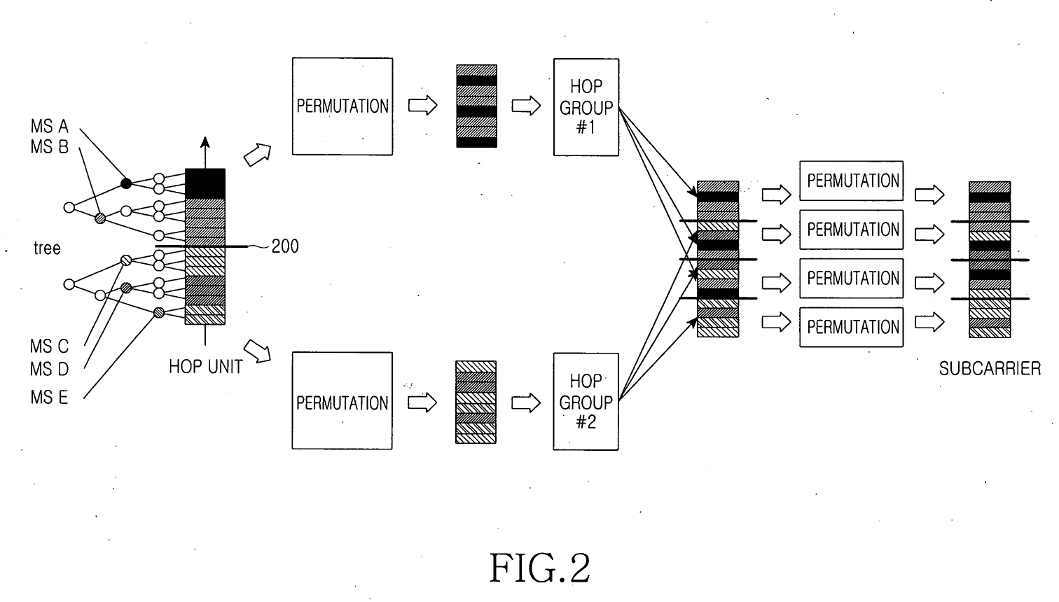

FIGS. 1 through 2, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless network.

Exemplary embodiments of the present invention provide an apparatus and method for allocating frequency resources so as to achieve a frequency diversity gain in an orthogonal frequency division multiple access (OFDMA) mobile communication system. In particular, the exemplary embodiments of the present invention provide an apparatus and method for allocating only part of a total frequency band in order to achieve a frequency diversity gain in an OFDMA mobile communication system. The partial frequency band is a preferred frequency band of an MS. The preferred frequency band can be a set of physically successive or discontinuous subcarriers. It is obvious that each MS may be allocated the same or a different frequency band in the OFDMA mobile communication system.

Before describing the present invention, terms used herein are defined as follows.

(1) Hop unit: Minimum frequency resources that can be allocated in a two-dimensional domain, i.e., in a time-frequency domain.

(2) Hop group: A set of hop units that hop in the same frequency band range.

(3) Subband: When the total frequency band of the OFDMA mobile communication system is divided into a plurality of bands each including physically successive subcarriers, each of the bands is called a subband.

A description will now be made of an apparatus and method for allocating frequency resources in an OFDMA mobile communication system according to an exemplary embodiment of the present invention.

According to the present invention, four processes are defined as follows.

Process 1: A plurality of hop units included in one hop group is allocated to each mobile station (MS) with one node Identification (ID). When hop units are represented by a hop unit tree, one hop unit is mapped to each lowest node in the hop unit tree. A different node ID is allocated to each node in the hop unit tree. If one node ID is allocated to a particular MS, hop units under a node identified by the node ID are allocated to the MS.

Process 1 is proposed to briefly represent frequency resources allocated to each MS.

Process 2: The sequence of a plurality of hop units included in each hop group is permuted. Process 2 is proposed to achieve a frequency diversity gain by allocating the hop units of each hop group to a plurality of subbands.

Process 3: The hop units of each hop group are allocated to subbands according to a predetermined rule.

Process 4: The sequence of hop units included in each subband is permuted. Process 4 is proposed to achieve a frequency diversity gain within one subband.

The above four processes will be described below in more detail.

In Process 1, a plurality of hop units included in one hop group corresponding to a preferred frequency band of each MS are allocated to the MS. As described above, if a node in a hop unit tree is allocated to the MS, all hop units under the node are used for the MS.

In Process 2, the sequence of hop units is permuted in each hop group. The length of a permutation sequence is determined by the number of hop units per hop group. The permutation sequence is generated to the determined length based on the index of a hopping time unit, a cell index, and a hop group index, for frequency hopping. The hopping time unit can be a symbol or a frame, for example. Therefore, a permutation sequence is generated at each hopping time unit and the sequence of hop units included in a hop group is permuted according to the permutation sequence.

In Process 3, the hop units of each hop group are allocated to subbands within a hopping frequency band range for the hop group. Therefore, a set of subbands for frequency hopping of each hop group is predetermined or set periodically in the OFDMA mobile communication system. The permuted hop units of the hop group are mapped sequentially to the subbands.

In Process 4, the sequence of the hop units mapped to each subband is permuted in the subband. A permutation sequence for the in-subband permutation is of a fixed length, determined according to the size of the subband.

A permutation sequence is generated to the determined length based on the index of a hopping time unit, a cell index, and a subband index, for frequency hopping. The permutation sequence is generated at each hopping time unit and the sequence of the hop units in the subband is permuted according to the permutation sequence. Finally, the permuted hop units are mapped to physical subcarriers corresponding to the permutated positions and transmitted on the subcarriers.

With reference to FIG. 1, the configuration of an OFDMA mobile communication system according to an exemplary embodiment of the present invention will be described.

FIG. 1 illustrates the configuration of an OFDMA mobile communication system according to an exemplary embodiment of the present invention.

Referring to FIG. 1, the OFDMA mobile communication system is designed in a multi-cell structure. Thus, it includes cells 100 and 150, a base station (BS) 110 that covers the cell 100, a BS 140 that covers the cell 150, and a plurality of mobile stations 111, 113, 130, 151, and 153.

The OFDMA mobile communication system can allocate frequency resources such that each mobile station (MS) can achieve a frequency diversity gain in its preferred frequency band. With reference to FIG. 2, a frequency resource allocation method in the OFDMA mobile communication system according to an exemplary embodiment of the present invention will be described.

FIG. 2 illustrates a frequency allocation method in the OFDMA mobile communication system according to an exemplary embodiment of the present invention.

In the illustrated case of FIG. 2, five mobile stations, MS A, MS B, MS C, MS D and MS E are to be allocated frequency resources in the OFDMA mobile communication system. Two hop groups, hop group #1 and hop group #2 are defined and four subbands, subband #1 to subband #4 are defined.

Referring to FIG. 2, MS A and MS B prefer subband #1, subband #2 and subband #3. That is, the preferred frequency bands of MS A and MS B are subband #1, subband #2 and subband #3. MS C, MS D, and MS E prefer subband #2, subband #3 and subband #4. That is, the preferred frequency bands of MS C, MS D, and MS E are subband #2, subband #3 and subband #4.

The ID of one node in a hop unit tree is allocated to each MS and thus hop units under the node are used for the MS. Therefore, it is to be noted that a node allocated to an MS and hop units under the node are hatched in the same manner for each MS.

Each MS is allocated to a node in a hop group corresponding to its preferred frequency band range (i.e., preferred frequency band). That is, nodes of hop group #1 are allocated to MS A and MS B, and nodes of hop group #2 are allocated to MS C, MS D and MS E. Reference numeral 200 denotes the boundary between hop group #1 and hop group #2.

The sequence of the hop units of each hop group is permuted according to a predetermined permutation sequence for the hop group. The permutation sequence is generated using the index of a hopping time unit, a cell index, and a hop group index, for frequency hopping. Then, the permuted hop units are allocated to subbands corresponding to the hop group. In FIG. 2, the hop units of hop group #1 are sequentially allocated to subband #1, subband #2 and subband #3, and the hop units of hop group #2 are sequentially allocated to subband #2, subband #3 and subband #4.

The sequence of the hop units of each subband is permuted according to a permutation sequence for the subband. The permutation sequence is generated using the index of a hopping time unit, a cell index, and a subgroup index, for frequency hopping. The permuted hop units are mapped to physical subcarriers corresponding to their positions, for a corresponding MS.

While an apparatus for performing the frequency resource allocation operation illustrated in FIG. 2 is not shown, a BS is generally responsible for the frequency resource allocation.

As is apparent from the above description, the present invention allocates frequency resources so that a frequency diversity gain can be achieved over a partial frequency band rather than over a total frequency band in an OFDMA mobile communication system. Therefore, the freedom of frequency resource allocation is increased in the OFDMA mobile communication system.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for allocating frequency resources in a base station in an orthogonal frequency division multiple access (OFDMA) mobile communication system, comprising:
allocating at least one hop unit to each mobile station, when a hop group includes a plurality of hop units, each hop unit being minimum frequency resources which can be allocated in a two dimensional time-frequency domain and a total frequency band of the OFDMA mobile communication system is divided into subbands;
permuting the sequence of hop units included in each hop group according to a first permutation sequence;
allocating the hop units of the each hop group to subbands;
permuting the sequence of hop units included in each of the subbands according to a second permutation sequence; and
determining the positions of the hop units permuted according to the second permutation sequence to be the positions of physical subcarriers allocated to the each mobile station.

2. The method of claim 1, wherein the first permutation sequence has a length corresponding to the number of the hop units included in the each hop group and is generated according to the index of a hopping time unit, a cell index, and a hop group index, for frequency hopping.

3. The method of claim 1, wherein the second permutation sequence has a length corresponding to the size of a subband and is generated according to the index of a hopping time unit, a cell index, and a subband index, for frequency hopping.

4. The method of claim 1, wherein the hop units included in the each hop group hop in the same frequency band range.

5. The method of claim 1, wherein the allocation of the hop units of the each hop group to subbands comprises allocating at least one hop unit included in each of at least two hop groups to the same subband.

6. An apparatus for allocating frequency resources in an orthogonal frequency division multiple access (OFDMA) mobile communication system, comprising:
a base station for when a hop group includes a plurality of hop units, each hop unit being minimum frequency resources which can be allocated in a two dimensional time-frequency domain and a total frequency band of the OFDMA mobile communication system are divided into subbands, allocating at least one hop unit to each mobile station, and permuting the sequence of hop units included in each hop group according to a first permutation sequence, allocating the hop units of the each hop group to subbands, permuting the sequence of hop units included in each of the subbands according to a second permutation sequence, and determining the positions of the hop units permutated according to the second permutation sequence to be the positions of physical subcarriers allocated to the each mobile station.

7. The apparatus of claim 6, wherein the first permutation sequence has a length corresponding to the number of the hop units included in the each hop group and is generated according to the index of a hopping time unit, a cell index, and a hop group index, for frequency hopping.

8. The apparatus of claim 6, wherein the second permutation sequence has a length corresponding to the size of a subband and is generated according to the index of a hopping time unit, a cell index, and a subband index, for frequency hopping.

9. The apparatus of claim 6, wherein the hop units included in the each hop group hop in the same frequency band range.

10. The apparatus of claim 6, wherein when the base station allocates the hop units of the each hop group to subbands, the base station allocates at least one hop unit included in each of at least two hop groups to the same subband.

11. An orthogonal frequency division multiple access (OFDMA) wireless network comprising a plurality of base stations for communicating with a plurality of mobile stations, wherein a total frequency band of the OFDMA wireless network is divided into subbands and the OFDMA wireless network allocates at least one hop unit to each mobile station, wherein each hop unit comprises a minimum frequency resource which can be allocated in a two dimensional time-frequency domain and wherein a plurality of hop units comprise a hop group, wherein the OFDMA wireless network allocates frequency resources to mobile stations by:
allocating at least one hop unit to each mobile station;
permuting the sequence of hop units included in each hop group according to a first permutation sequence;
allocating the hop units of the each hop group to subbands;
permuting the sequence of hop units included in each of the subbands according to a second permutation sequence; and
determining the positions of the hop units permutated according to the second permutation sequence to be the positions of physical subcarriers allocated to the each mobile station.

12. The OFDMA wireless network of claim 11, wherein the first permutation sequence has a length corresponding to the number of the hop units included in the each hop group and is generated according to the index of a hopping time unit, a cell index, and a hop group index, for frequency hopping.

13. The OFDMA wireless network of claim 11, wherein the second permutation sequence has a length corresponding to the size of a subband and is generated according to the index of a hopping time unit, a cell index, and a subband index, for frequency hopping.

14. The OFDMA wireless network of claim 11, wherein the hop units included in the each hop group hop in the same frequency band range.

15. The OFDMA wireless network of claim 11, wherein when the OFDMA wireless network allocates the hop units of the each hop group to subbands, the OFDMA wireless network allocates at least one hop unit included in each of at least two hop groups to the same subband.
